(19) United States
(12) Patent Application Publication
(10) Pub. No.: US 2013/0059269 A1
(43) Pub. Date: Mar. 7, 2013

(54) DENTAL SCREW AND DRIVER

(71) Applicant: Jang Hoon Ahn, Seoul (KR)

(72) Inventor: Jang Hoon Ahn, Seoul (KR)

(21) Appl. No.: 13/696,598

(22) PCT Filed: Apr. 19, 2011
(86) PCT No.: PCT/KR2011/002768

§ 371 Date: Nov. 7, 2012

(30) Foreign Application Priority Data
May 7, 2010 (KR) 10-2010-0043183

(51) Int. Cl. A61C 19/00; A61C 3/00

(52) U.S. Cl. 433/141; 433/215

(57) ABSTRACT

The dental screw of the present invention includes a head part having a tightening groove for transmitting a rotational force of a driver, and a screw part having screw threads in the longitudinal direction wherein the head part further includes a fixing groove at the central portion of the tightening groove to prevent the screw from being disengaged from the driver. The dental screw driver of the present invention is a dental screw driver including a tightening part and a supporting part wherein the tightening part includes a tightening projection which fits into the tightening groove of the dental screw and a fixing tip disposed at the tip of the tightening part so as to be inserted into the tightening groove. According to the dental screw and driver of the present invention, the screw rarely disengages from the driver when the screw is being tightened or removed from an oral cavity of a recipient, and unexpected accidents caused by a stray screw may be prevented during dental surgical procedures, such as those involving implants and orthodontics.

### TECHNICAL FIELD

The present invention relates to a dental screw and a driver, and more particularly, to a dental screw and a driver used for implants and orthodontics, etc.

### BACKGROUND ART

In general, a screw is a kind of peg, which is used for assembling two objects and fixing them together. Consecutive spiral grooves (screw threads) are formed in a longitudinal direction thereon. The screw is rotated in one direction by using a driver to tighten two objects together. The two objects are released when the screw is rotated in an opposite direction, if necessary.

In a field of dental procedures such as implants and orthodontics, a screw has been widely used in dental operations and, in particular, it has been used when attaching a fixture for applying continuous tension to a tooth to be corrected to an oral cavity of a person with orthodontics. For example, a predetermined fixture as an anchor for orthodontics is attached on a palate (the roof of the mouth differentiating an oral cavity and a nasal cavity), and a steel wire is connected to plates attached to the teeth to be corrected. The steel wire is connected to the fixture by using a spring or rubber wire to apply tension. Here, the fixture is fixed to a cortical bone or a spongy bone in the palate by using a screw.

Meanwhile, the screw that is used in a dental operation is very small in size (about lcm or less), as compared to the screw that is used in a general mechanical component. Thus, the screw has to be handled cautiously. Specially, since the dental operation is performed within an oral cavity of a recipient, the tightening and removal of the screw with a driver is not easily performed. That is, when a screw is rested on a tip of a driver and the screw is tightened within an oral cavity of a recipient, the screw can be disengaged easily from the driver. Further, when the driver is rotated forcibly at an unintended angle, the screw head (generally having a cross type or a line type groove) can become worn. If the screw is disengaged from the driver during a dental operation for orthodontics, it can leave injury within an oral cavity of a recipient, and in a serious case, a medical accident can occur if the recipient swallows the screw. Further, when the head of the screw is worn by the driver, the screw is difficult to be removed after correcting a set of teeth.

### DISCLOSURE

### Technical Problem

The present invention has been proposed to solve the problem of a prior dental screw and an object of the present invention is to provide a dental screw and a driver where the screw can be prevented from being disengaged easily from the driver.

Another object of the present invention is to provide a dental screw and a driver in which when the screw is tightened or removed by using the driver within an oral cavity of a recipient, the driver can be rotated while it is fitted fully into the groove formed on the screw.

### Technical Solution

A dental screw according to the present invention includes a head part in which a tightening groove for transmitting rotational force of a driver is formed; and a screw part on which screw threads are formed in a longitudinal direction wherein a fixing groove is further formed at a center of the tightening groove of the head part to prevent the driver from being disengaged.

Furthermore, the head part is tapered such that its diameter decreases gradually from the upper end, and the screw part is tapered such that its diameter decreases gradually from the upper end. Further, the fixing groove is tapered such that its inside diameter decreases gradually from the upper end toward the lower end.

A dental screw driver according to the present invention includes a tightening part and a support part wherein the tightening part comprises: a tightening projection to be fitted into the tightening groove of the dental screw according to the present invention; and a fixing tip that is formed on a remote end of the tightening part and is inserted into the fixing groove. Here, a lever groove into which a lever is inserted is formed on the support part.

### Advantageous Effects

According to the dental screw and driver of the present invention, the screw rarely disengages from the driver when the screw is being tightened or removed from an oral cavity of a recipient. Unexpected accidents caused by a stray screw may be prevented during dental surgical procedures, such as those involving implants and orthodontics.

Further, the dental screw and driver of the present invention can be rotated only while the screw is fitted fully into the driver, and thus the screw can be prevented from being worn due to rotation of the driver while the driver is not fitted fully into the tightening groove of the screw.

### BRIEF DESCRIPTION OF THE DRAWINGS

FIG. 1 is a flat view of a head part of a dental screw according to an example of an embodiment of the present invention.

FIG. 2 is a cross-sectional view of a dental screw, taken along line A-A′ in FIG. 1.

FIG. 3 is a flat view of a dental driver according to an example of an embodiment of the present invention.

FIG. 4 is a partially exploded view of one end (A area) of a tightening part of the dental driver as shown in FIG. 3.

FIG. 5 is a partially exploded view of a support part of a dental driver according to another embodiment of the present invention.

### BEST MODE

Embodiments of the present invention will be described below in detail with reference to the accompanying drawings. Wherever possible, the same reference numerals will be used to refer to the same elements throughout the specification, and a duplicated description thereof will be omitted. It will be understood that although the terms “first”, “second”, etc. are used herein to describe various elements, these elements should not be limited by these terms. These terms are only used to distinguish one element from another element.

A dental screw according to the present invention includes a head part in which a tightening groove for transmitting rotational force of a driver is formed; and a screw part on which screw threads are formed in a longitudinal direction wherein a fixing groove is further formed at a center of the tightening groove of the head part to prevent the driver from being disengaged.

Furthermore, the head part is tapered such that its diameter decreases gradually from the upper end, and the screw part is tapered such that its diameter decreases gradually from the upper end. Further, the fixing groove is tapered such that its diameter decreases gradually from the upper end toward the lower end.

A dental screw driver according to the present invention includes a tightening part and a support part wherein the tightening part comprises: a tightening projection to be fitted into the tightening groove of the dental screw according to the present invention; and a fixing tip that is formed on a remote end of the tightening part and is inserted into the fixing groove. Here, a lever groove into which a lever is inserted is formed on the support part.

### Mode for the Invention

Hereinafter, preferable embodiments of a dental screw and a driver according to the present invention will be described in detail, referring the accompanying drawings.

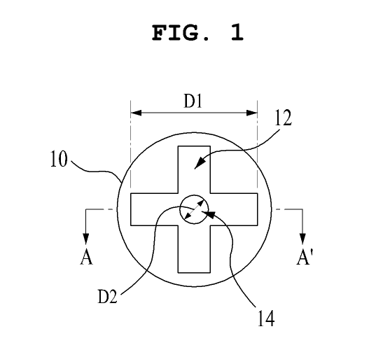

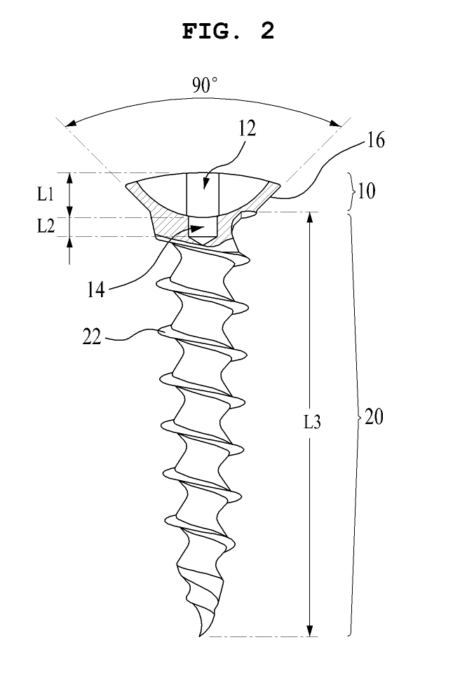

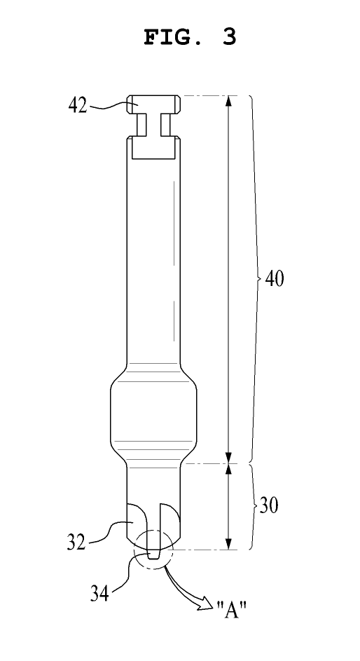

First, referring to FIGS. 1 and 2, a dental screw according to an example of an embodiment will be described. A dental screw includes a head part 10 and a screw part 20. Here, a tightening groove 12 through which a rotational force of the driver (see FIG. 3) is transmitted is formed on the head part 10. The tightening groove 12 is shaped, into which a tightening projection (32 in FIG. 3) formed on one end of the driver is fitted wherein the rotational torque of the driver is transmitted through the tightening groove 12 and the tightening projection 32. In the present embodiment, the tightening groove 12 and the tightening projection 32 are shaped as example of an cross type; however, they are not limited thereto, and may include various shapes such as a line type, a hexagon type, a quadrangle type, etc. Further, screw threads 22 are formed on the screw part 20 in its longitudinal direction.

In addition, a fixing groove 14 is formed at a center of the tightening groove 12 on the head part 10. A fixing tip 34 formed on one end of the tightening part 30 of the driver may be inserted into the fixing groove 14. When the tightening projection 32 and the fixing tip 34 of the driver are assembled to the tightening groove 12 and the fixing groove 14, respectively, during the operation, the screw cannot be disengaged easily from the driver. That is, a length L3 of the screw part 20 of the dental screw is about 10 millimeters or so, and a diameter of the head part 10 is about 2 mm or so, which are fine-sized. Accordingly, even when a screw and a driver of a general type are used, it is difficult for the screw to be rested on the driver, and further it is extremely difficult for the screw to be fixed within an oral cavity of a recipient during a dental operation. Under this circumstance, various medical accidents including serious accidents occur frequently due to the disengagement of the screw from the driver during the operation. However, in case of the screw according to the present invention, the screw is arranged easily on the driver by the fixing groove 14, and further even when the driver is titled to some extent while the screw is rested on the driver, the screw is not disengaged easily from the driver.

With respect to the size of the fixing groove 14, when a diameter of the head part 10 is about 2-3 mm and a full length of the screw is 8-10 mm, a depth L1 of the tightening groove 12 may be about 0.85 mm, and a depth L2 of the fixing groove 14 may be about 0.36 mm. Further, when a width D1 of the tightening groove 12 is about 2.4 mm, a width D2 of the fixing groove 14 may be about 0.54 mm. Furthermore, if a fixing force between the screw and the driver in the fixing groove 14 is too firm, the driver may not be drawn out easily from the screw or the fixing tip inserted into the fixing groove 14 may be worn when the driver is disengaged from the screw while rotating the driver. Accordingly, the fixing groove 14 may be tapered such that the inner diameter thereof decreases gradually from the upper end to the lower end, and the driver can be disengaged easily from the screw when the driver is intended to be removed from the screw, even though the screw is not disengaged easily from the driver with some attention through this taper shape.

In addition to this taper shape of the fixing groove, the head part 10 may be tapered such that its diameter decreases gradually from the upper end. That is, a sidewall of the head part 10 may be formed as an inclined sidewall 16 wherein its sectional face is inclined, as shown in FIG. 2. The screw according to the present invention may be used for orthodontics. That is, it may be used for implanting a predetermined fixture to a palate or gum of a recipient. In this case, when the screw is tightened to a palate or gum of a recipient through a predetermined hole formed in the fixture, the head part 10 of the screw is fixed to the fixture through the inclined sidewall 16. Further, the screw part 20 is tapered such that its diameter decreases gradually from upper end so that the screw is tightened easily to a palate or gum of a recipient.

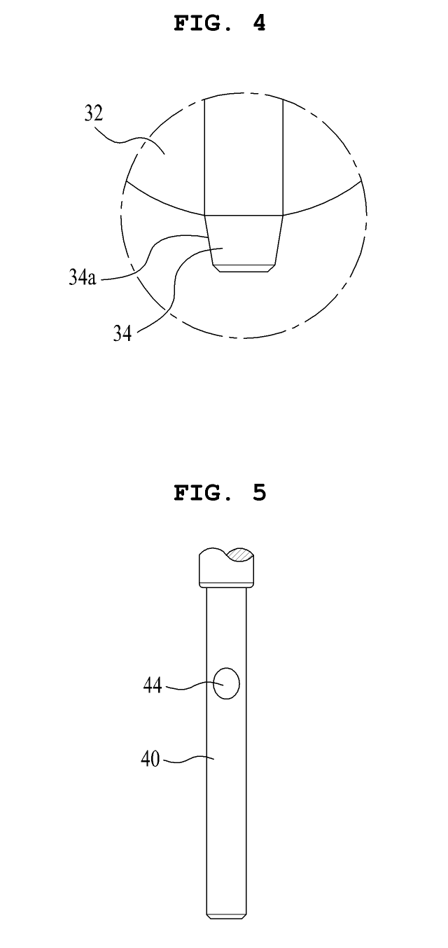

Next, referring to FIGS. 3 and 4, a dental screwdriver according to an example of an embodiment will be described. As shown in FIG. 3, the screwdriver includes a tightening part 30 and a support part 40. Here, a tightening projection 32 to be fitted into the tightening groove 12 as shown in FIGS. 1 and 2 is formed on the tightening part 30. Further, a fixing tip 34 to be inserted into the fixing groove 14 is formed at a center of a remote end of the tightening part 30.

Specially, the fixing tip 34 may be tapered such that its diameter decreases toward its remote end in accordance to a shape of the fixing groove 14, as shown in FIG. 4. For example, the fixing tip 34 may have an inclined sidewall 34a. Further, it is understood clearly by a person who has ordinary skill in the art to which the invention pertains that the sizes of the tightening projection 32 and the fixing tip 34 may be selected in accordance to the sizes of the tightening groove 12 and the fixing groove 14.

The support part 40 is connected to a separate lever for an operator to rotate the screw, and for this purpose a connection member 42 may be formed on one end of the support part 40. Furthermore, in addition to the connection member 42, as shown in FIG. 5, a predetermined lever groove 44 is formed on the support part 40 and then a predetermined lever is inserted vertically to the support part 40 into the lever groove for rotation.

The present invention relates a dental screw and driver used for implants and orthodontics.

According to the dental screw and driver of the present invention, the screw rarely disengages from the driver when the screw is being tightened or removed from an oral cavity of a recipient. Unexpected accidents caused by a stray screw may be prevented during dental surgical procedures, such as those involving implants and orthodontics.

Further, the dental screw and driver of the present invention can be rotated only while the screw is fitted fully into the driver, and thus the screw can be prevented from being worn due to excessive rotation while the driver is not fitted fully into the tightening groove of the driver.

While the present invention has been described with respect to the specific embodiments, it will be apparent to those skilled in the art that various changes and modifications may be made without departing from the spirit and scope of the invention as defined in the following

1. A dental screw comprising:
a head part in which a tightening groove for transmitting rotational force of a driver is formed; and
a screw part on which screw threads are formed in a longitudinal direction wherein a fixing groove is further formed at a center of the tightening groove of the head part to prevent the driver from being disengaged.

2. The dental screw of claim 1, wherein the head part is tapered such that its diameter decreases gradually from the upper end.

3. The dental screw of claim 1, wherein the screw part is tapered such that its diameter decreases gradually from the upper end.

4. The dental screw of claim 1, wherein the fixing groove is tapered such that its inside diameter decreases gradually from the upper end toward the lower end.

5. A dental screwdriver comprises a tightening part and a support part wherein the tightening part comprises:
a tightening projection to be fitted into the tightening groove of the dental screw according to claim 1; and
a fixing tip that is formed on a remote end of the tightening part and is inserted into the fixing groove.

6. The dental screwdriver of claim 5, wherein a lever groove into which a lever is inserted is formed on the support part.
